(19) United States
(12) Patent Application Publication
(10) Pub. No.: US 2025/0271072 A1
(43) Pub. Date: Aug. 28, 2025

(54) LAVATORY FAUCET WITH CENTER WATER INLET

(71) Applicant: AS America, Inc., Piscataway, NJ (US)

(72) Inventors: Xiaojing YE, Edison, NJ (US); Marin MARINOV, East Brunswick, NJ (US)

(73) Assignee: AS America, Inc., Piscataway, NJ (US)

(21) Appl. No.: 19/060,998

(22) Filed: Feb. 24, 2025

Related U.S. Application Data
(60) Provisional application No. 63/558,362, filed on Feb. 27, 2024.

(51) Int. Cl. F16K 11/00; E03C 1/04; F16K 11/20

(52) U.S. Cl. CPC F16K 19/006; E03C 1/04; F16K 11/20

(57) ABSTRACT

A faucet assembly includes a bridge having a central water inlet configured to removably connect to a cold water supply line and a hot water supply line; a cold water valve connected to the bridge at a first end of the bridge and configured to receive cold water from a lower cold water pathway; and a hot water valve connected to the bridge at a second end of the bridge and configured to receive hot water from a lower hot water pathway, wherein the bridge includes a mixing chamber for receiving cold water from the cold water valve via an upper cold water pathway and hot water from the hot water valve via an upper hot water pathway. The faucet assembly may have a central extended shank or extended side shanks extending below the cold water valve and the hot water valve respectively.

### CROSS-REFERENCE TO RELATED APPLICATION

This application claims the benefit of U.S. Provisional Application No. 63/558,362, filed Feb. 27, 2024, the entire contents of which is incorporated herein by reference.

### FIELD

The present disclosure generally relates to lavatory faucets, and more particularly, to lavatory faucets having a center water inlet.

### BACKGROUND

A dual control lavatory faucet includes a hot water control and a cold water control. Generally, within each control resides a cartridge or valve that controls the flow rate of the water flowing to the cartridge from a water supply line. The relative position of the cartridge controls the flow rate of the water flowing from the water supply line, through the cartridge, and to a mixing chamber, which receives water from both a hot water supply line (via a hot water cartridge) and a cold water supply line (via a cold water cartridge). From the mixing chamber, the mixed temperature water flows through an outlet tube and out of the faucet outlet.

Dual control lavatory faucet assemblies are configured to connect to the water supply lines (i.e., hot water supply line and cold water supply line) directly at their respective cartridges. Therefore, the cold water supply line connects the main water supply to the faucet assembly at the cold water cartridge of the assembly, and the hot water supply line connects the main water supply to the faucet assembly at the hot water cartridge of the assembly. Dual control faucets require three openings in the sink deck or other mounting surface to connect the faucet assembly to the hot and cold water supply lines.

### SUMMARY

Provided herein are faucet assemblies comprising a center water inlet. Unlike conventional dual control lavatory faucet assemblies, which receive a cold water inlet at the cold water cartridge and a hot water inlet at the hot water cartridge (i.e., through the side openings of the sink deck or mounting surface), the faucet assemblies described herein receive both the hot water inlet and the cold water inlet at a central location, or through the central opening of the sink deck or mounting surface to which the faucet assembly is configured to mount. This configuration allows the dual faucet assembly to be mounted to a single-opening sink deck or mounting surface (i.e., it doesn't require three openings). Additionally, in some embodiments, the faucet assembly includes the cold and hot water supply lines, preventing the user from having to purchase the water supply lines separately as is required with conventional faucet assemblies.

To accommodate the central water inlet, the faucet assemblies described herein include a bridge that connects the water supply lines, cartridges, and water outlet. Specifically, the water supply lines are configured to couple to the bridge. Hot water flows from a hot water supply line to the bridge, and from the bridge to the hot water cartridge. From the hot water cartridge, the hot water flows to a mixing chamber, mixes with the cold water, and then flows out through the water outlet. Similarly, cold water flows from the cold water inlet to the bridge, and from the bridge to the cold water cartridge. From the cold water cartridge, the cold water flows to a mixing chamber, mixes with the hot water, and then flows out through the water outlet.

A faucet assembly as described herein comprises one or more extended shanks. These extended shanks are configured to pass through an opening in the sink deck or mounting surface to which the faucet assembly can be mounted. The extended shank(s) can be threaded, such that a nut can be coupled to the extended shank, securing the faucet assembly to the sink deck or mounting surface. In some embodiments, a faucet assembly as described herein may comprise a central extended shank. In some embodiments, a faucet assembly may comprise extended side shanks. In some embodiments, a faucet assembly may comprise both extended side and central shanks. A faucet assembly with only one extended shank (i.e., a central extended shank) allows a dual control faucet assembly to be mounted to a sink deck or mounting surface with only one opening, whereas conventional dual control faucet assemblies generally require three openings in the sink deck or mounting surface to be mounted.

Another benefit of the faucet assemblies provided herein is that they are provided with the water supply lines. In many conventional faucet assemblies, a user is required to purchase the water supply lines separately from the faucet assembly. However, as provided herein, the water supply lines can be included as part of the faucet assembly, reducing the total number of parts that the user needs to source and purchase.

In some embodiments, provided is a faucet assembly, the faucet assembly comprising: a bridge comprising a central water inlet configured to removably connect to a cold water supply line and a hot water supply line; a cold water valve housed within a cold water valve housing comprising an extended shank configured to pass through a first opening in a mounting surface, wherein the cold water valve housing is connected to the bridge at a first end of the bridge and the cold water valve is configured to receive cold water from a lower cold water pathway in the bridge; and a hot water valve housed within a hot water valve housing comprising an extended shank configured to pass through a second opening in the mounting surface, wherein the hot water valve housing is connected to the bridge at a second end of the bridge and the hot water valve is configured to receive hot water from a lower hot water pathway in the bridge, wherein the bridge comprises a mixing chamber configured to receive cold water from the cold water valve via an upper cold water pathway in the bridge and hot water from the hot water valve via an upper hot water pathway in the bridge.

In some embodiments of the faucet assembly, the bridge does not comprise a central extended shank configured to pass through a central opening in the mounting surface.

In some embodiments of the faucet assembly, the lower cold water pathway, the lower hot water pathway, the upper cold water pathway, and the upper hot water pathway are each horizontal.

In some embodiments of the faucet assembly, the upper cold water pathway is configured to transport cold water in a first direction and the lower cold water pathway is configured to transport cold water in a second direction, wherein the first direction and the second direction are opposite.

In some embodiments of the faucet assembly, the upper hot water pathway is configured to transport water in a third direction and the lower hot water pathway is configured to transport water in a fourth direction, wherein the third direction and the fourth direction are opposite.

In some embodiments of the faucet assembly, the upper cold water pathway is directly above the lower cold water pathway, and the upper hot water pathway is directly above the lower hot water pathway.

In some embodiments of the faucet assembly, the bridge comprises an engineering thermoplastic.

In some embodiments of the faucet assembly, the engineering thermoplastic is selected from the group consisting of polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof.

In some embodiments of the faucet assembly, the bridge comprises a glass-filled polyamide or a glass-filled polyphthalamide.

In some embodiments of the faucet assembly, the bridge comprises an injection molded thermoplastic.

In some embodiments of the faucet assembly, the bridge comprises at least one of an engineering thermoplastic, a glass-filled polyamide, a glass-filled polyphthalamide, or an injection molded thermoplastic.

In some embodiments of the faucet assembly, the mounting surface comprises the first opening for the extended shank of the cold water valve housing, the second opening for the extended shank of the hot water valve housing, and a central opening for the cold water supply line and the hot water supply line.

In some embodiments of the faucet assembly, the cold water supply line and the hot water supply line are configured to connect to the bridge at a location that is below the mixing chamber of the bridge.

In some embodiments of the faucet assembly, the faucet assembly comprises an outlet tube configured to removably connect to the bridge and receive mixed water from the mixing chamber.

In some embodiments, provided is a faucet assembly comprising: a bridge comprising a central extended shank comprising a central water inlet configured to removably connect to a cold water supply line and a hot water supply line; a cold water valve connected to the bridge at a first side and configured to receive cold water from a lower cold water pathway in the bridge; and a hot water valve connected to the bridge at a second side and configured to receive hot water from a lower hot water pathway in the bridge, wherein the bridge comprises a mixing chamber configured to receive cold water from the cold water valve via an upper cold water pathway in the bridge and hot water from the hot water valve via an upper hot water pathway in the bridge.

In some embodiments of the faucet assembly, the central extended shank of the bridge comprises a cold water pathway connecting the cold water supply line to the lower cold water pathway of the bridge and a hot water pathway connecting the hot water supply line to the lower hot water pathway of the bridge.

In some embodiments of the faucet assembly, the cold water valve is housed within a cold water valve housing that does not comprise an extended shank, and the hot water valve is housed within a hot water valve housing that does not comprise an extended shank.

In some embodiments of the faucet assembly, the lower cold water pathway, the lower hot water pathway, the upper cold water pathway, and the upper hot water pathway are each horizontal.

In some embodiments of the faucet assembly, the upper cold water pathway is configured to transport cold water in a first direction and the lower cold water pathway is configured to transport cold water in a second direction, wherein the first direction and the second direction are opposite.

In some embodiments of the faucet assembly, the upper hot water pathway is configured to transport water in a third direction and the lower hot water pathway is configured to transport water in a fourth direction, wherein the third direction and the fourth direction are opposite.

In some embodiments of the faucet assembly, the upper cold water pathway is directly above the lower cold water pathway, and the upper hot water pathway is directly above the lower hot water pathway.

In some embodiments of the faucet assembly, the bridge comprises an engineering thermoplastic.

In some embodiments of the faucet assembly, the engineering thermoplastic is selected from the group consisting of polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof.

In some embodiments of the faucet assembly, the bridge comprises a glass-filled polyamide or a glass-filled polyphthalamide.

In some embodiments of the faucet assembly, the bridge comprises an injection molded thermoplastic.

In some embodiments of the faucet assembly, the faucet assembly is configured to mount to a mounting surface comprising a single opening through which the central extended shank of the bridge is configured to pass through and a mounting surface comprising three openings, wherein the central extended shank of the bridge is configured to pass through a central opening of the three openings.

In some embodiments of the faucet assembly, the cold water supply line and the hot water supply line are configured to connect to the bridge at a location that is below the mixing chamber of the bridge.

In some embodiments of the faucet assembly, the faucet assembly comprises an outlet tube configured to removably connect to the bridge and receive mixed water from the mixing chamber.

In some embodiments, any one or more of the features, characteristics, or elements discussed above with respect to any of the embodiments may be incorporated into any of the other embodiments mentioned above or described elsewhere herein.

### BRIEF DESCRIPTION OF THE FIGURES

FIG. 1 shows a perspective view of a faucet assembly having a central water inlet, according to some embodiments;

FIG. 2 shows a cross-sectional view of a faucet assembly having a central water inlet and comprising extended side shanks, according to some embodiments;

FIG. 3 shows a cross-sectional view of a dual control faucet comprising a faucet assembly having a central water inlet and extended side shanks, according to some embodiments;

FIG. 4 shows a perspective view of a faucet assembly having a central water inlet and comprising a central extended shank, according to some embodiments; and

FIG. 5 shows a cross-sectional view of a faucet assembly having a central water inlet and comprising a central extended shank, according to some embodiments.

### DETAILED DESCRIPTION

Provided are faucet assemblies comprising a central water inlet. Conventional dual control faucet assemblies receive the hot water supply line and the cold water supply line at opposing ends of the faucet assembly (i.e., below the hot control and cold control, respectively). However, the faucet assemblies provided receive both the hot water supply line and the cold water supply line centrally, or below the outlet tube of a dual control faucet. This configuration allows a dual control faucet assembly to be mounted on a sink deck or mounting surface that only has one opening (i.e., is configured for a single control faucet).

In some embodiments, the faucet assemblies provided herein are provided with the water supply lines coupled to the faucet assembly. This can enable a user to more easily purchase and install the faucet assembly. Specifically, conventional dual control faucet assemblies require additionally sourcing and purchasing the water supply lines. However, in this case, the water supply lines can be included with the faucet assembly for purchase. Additionally, having the water supply lines already coupled to the faucet assembly allows a user to more easily install the faucet assembly. The water supply lines (already coupled to the faucet assembly) can be easily threaded down through a single (or central) opening in the sink deck or mounting surface. The opposing ends of the water supply lines (those not coupled to the faucet assembly) simply need to be coupled to the main water supply. Without having the water supply lines already coupled to the faucet assembly, a user generally has to reach up underneath the sink deck to couple the water supply lines to the faucet assembly. This can be uncomfortable and difficult to do.

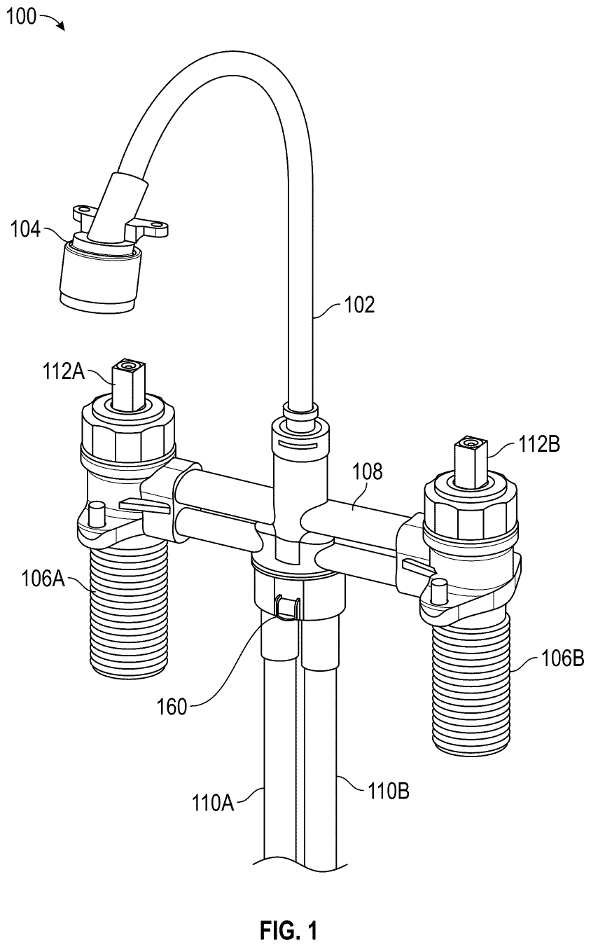

FIG. 1 shows a perspective view of a lavatory faucet with center water inlet 100, according to some embodiments. The lavatory faucet with center water inlet 100 includes an outlet tube 102, faucet outlet 104, cold water shank 106A, hot water shank 106B, bridge 108, cold water supply line 110A, hot water supply line 110B, cold water valve stem 112A, hot water valve stem 112B, and metal clip 160.

As shown, lavatory faucet with center water inlet 100 is a dual control faucet, meaning that the faucet is controlled with two separate controls—a cold water control and a hot water control. The cold water control comprises cold water valve stem 112A, cold water shank 106A, and cold water supply line 110A. The hot water control comprises hot water valve stem 112B, hot water shank 106B, and hot water supply line 110B. In a conventional dual control faucet, the water supply lines (i.e., cold water supply line 110A and hot water supply line 110B) are coupled to the faucet assembly at the water valves. Thus, in a conventional dual control faucet, the cold water supply line 110A would be connected directly to the cold water valve (e.g., through the cold water shank 106A) and the hot water supply line 110B would be connected directly to the hot water valve (e.g., through the hot water shank 106B).

However, as shown in FIG. 1, this is not the case in the disclosed lavatory faucet with center water inlet 100. Instead, the cold water supply line 110A and the hot water supply line 110B are connected to the cold water valve and the hot water valve indirectly through the bridge 108 of the lavatory faucet with center water inlet 100. The bridge 108 comprises waterways directing cold water from the cold water supply line 110A to the cold water valve, and from the cold water valve to a mixing chamber within the bridge 108 where the cold water mixes with hot water, and from the mixing chamber to the outlet tube 102 and faucet outlet 104. The bridge 108 also comprises waterways directing hot water from the hot water supply line 110B to the hot water valve, and from the hot water valve to the mixing chamber where the hot water mixes with the cold water, and from the mixing chamber to the outlet tube 102 and faucet outlet 104. By having both the cold water supply line 110A and the hot water supply line 110B connect to the rest of the faucet assembly at a central location, this allows for the faucet assembly to be mounted to a surface deck having only a single opening. Traditionally, surface decks having only one opening can only accommodate a single-control or a single handle faucet assembly. However, the configuration described herein (i.e., dual-control faucet assembly with center water inlet) allows a dual-control faucet assembly to be mounted to a surface deck with only a single opening.

The two water supply lines (i.e., cold water supply line 110A and hot water supply line 110B) are connected to the bridge 108 via a fastening mechanism. In some embodiments, the fastening mechanism may be a metal clip, as shown in FIG. 1 as item 160. This metal clip secures the cold water supply line 110A to the bridge 108 and the hot water supply line 110B to the bridge 108. A fastening mechanism such as metal clip 160 allows the water supply lines to be securely fastened, yet easily unfastened at the same time (for replacement, installation, etc.).

In some embodiments, the outlet tube 102 may be configured to removably attach to the bridge 108. The outlet tube 102 can receive mixed water from a mixing chamber of the bridge 108.

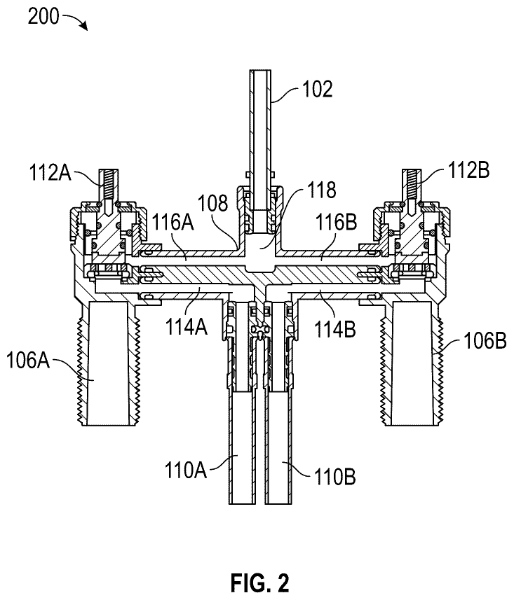

FIG. 2 shows a cross-sectional view of a faucet assembly 200 having a central water inlet and comprising extended side shanks, according to some embodiments. As shown, faucet assembly 200 includes outlet tube 102, cold water shank 106A, hot water shank 106B, bridge 108, cold water supply line 110A, hot water supply line 110B, cold water valve stem 112A, and hot water valve stem 112B. Bridge 108 comprises lower cold water pathway 114A, lower hot water pathway 114B, upper cold water pathway 116A, upper hot water pathway 116B, and mixing chamber 118. In some embodiments, the faucet assembly 200 may comprise extended side shanks, but not a central extended shank.

The specific faucet assembly configuration shown in FIG. 2 can be mounted to a surface deck having three openings. The cold water supply line 110A and hot water supply line 110B are configured to pass through a central opening in a surface deck. The cold water shank 106A and hot water shank 106B are both extended shanks, meaning that they are each configured to pass though a side opening in a surface deck having three openings. The extended shanks are designed to secure the faucet assembly 200 to the surface deck. In some embodiments, the cold water shank 106A and hot water shank 106B are threaded to allow for mounting and easily securing to the mounting surface.

Faucet assembly 200 is configured to receive cold water at cold water supply line 110A. Cold water supply line 110A is configured to connect to bridge 108 at one end (as shown) and a water supply at an opposing end. From the water supply, the cold water passes through the cold water supply line 110A vertically upwards and enters the bridge 108 at a central location (with respect to the faucet assembly 200) on a lower side of the bridge 108. Once in the bridge 108, the cold water runs horizontally through the lower cold water pathway 114A and to the cold water valve inlet (in a direction away from a center of the faucet assembly). The cold water valve stem 112A may be controlled by a user control (e.g., handle, knob). The specific rotation location of the cold water valve stem 112A controls the amount of cold water (or flow rate of cold water) that enters and exits the cold water valve. From the cold water valve, the cold water exits at the cold water valve outlet and reenters the bridge 108 at the upper cold water pathway 116A. The upper cold water pathway 116A directs the cold water back in to the center of the faucet assembly 200. Specifically, cold water flows from the cold water valve outlet horizontally through the upper cold water pathway 116A and to a mixing chamber 118. The mixing chamber is designed to receive both the cold water and hot water and mix them to form mixed temperature water. The mixing chamber 118 can be located at a central location (with respect to the faucet assembly 200). In some embodiments, the mixing chamber may be located directly above the central water inlet (i.e., the location at which the cold water supply line 110A and the hot water supply line 110B connect to the bridge 108). In some embodiments, the mixing chamber 118 is located directly below the outlet tube 102.

Faucet assembly 200 is configured to receive hot water at hot water supply line 110B. Hot water supply line 110B is configured to connect to bridge 108 at one end (as shown) and a water supply at an opposing end. From the water supply, the hot water passes through the hot water supply line 110B vertically upwards and enters the bridge 108 at a central location (with respect to the faucet assembly 200) on a lower side of the bridge 108. Once in the bridge 108, the hot water runs horizontally through the lower hot water pathway 114B and to the hot water valve inlet (in a direction away from a center of the faucet assembly). The hot water valve stem 112B may be controlled by a user control (e.g., handle, knob). The specific rotation location of the hot water valve stem 112B controls the amount of hot water (or flow rate of hot water) that enters and exits the hot water valve. From the hot water valve, the hot water exits at the hot water valve outlet and reenters the bridge 108 at the upper hot water pathway 116B. The upper hot water pathway 116B directs the hot water back in to the center of faucet assembly 200. Specifically, hot water flows from the hot water valve outlet horizontally through the upper hot water pathway 116B and to a mixing chamber 118. The mixing chamber is designed to receive both the hot water and cold water and mix them to form mixed temperature water.

Each upper water path in bridge 108 may be directly above its corresponding lower water path. Therefore, in some embodiments, this means that the upper cold water pathway 116A is directly above the lower cold water pathway 114A, and similarly, upper hot water pathway 116B is directly above lower hot water pathway 114B. In some embodiments, the cold water running through upper cold water pathway 116A runs in a direction that is directly opposite the direction that the cold water in lower cold water pathway 114A runs. Similarly, in some embodiments, the hot water running through upper hot water pathway 116B runs in a direction that is directly opposite the direction that the hot water in lower hot water pathway 114B runs.

As described above, the mixing chamber 118 receives cold water from upper cold water pathway 116A and hot water from upper hot water pathway 116B. The hot water and the cold water in mixing chamber 181 mixes to form mixed temperature water. From the mixing chamber 118, the mixed temperature water is directed to a conduit in the outlet tube 102 and out through the faucet outlet.

The cold water supply line 110A and the hot water supply line 110B can be configured to connect to the bridge 108 at a location that is directly below a mixing chamber 118 of the bridge 108.

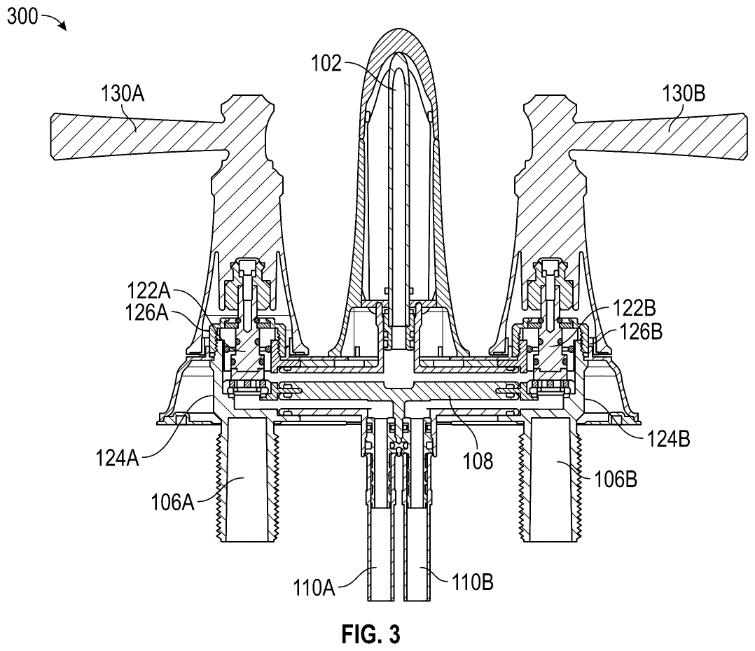

FIG. 3 shows another cross-sectional view of a dual control faucet comprising a faucet assembly 300 having a central water inlet and extended side shanks, according to some embodiments. Specifically, FIG. 3 shows the faucet assembly with user controls 130A (cold water) and 130B (hot water). Also shown in FIG. 3 are the cold water supply line 110A, hot water supply line 110B, cold water valve housing 124A, hot water valve housing 124B, cold water valve 122A, hot water valve 122B, locking nut 126A for cold water valve 122A, locking nut 126B for hot water valve 122B, outlet tube 102, cold water user control 130A, and hot water user control 130B. As shown, like the configuration shown in FIG. 2, the configuration here also includes cold water shank 106A and hot water shank 106B that are extended, meaning that they can extend through side openings in a mounting surface having three openings (i.e., designed for a conventional dual-control faucet assembly).

As shown and described in more detail with respect to FIG. 2, cold water enters the faucet assembly at cold water supply line 110A and passes to the bridge 108. From the bridge 108, the cold water enters cold water valve 122A which is situated within cold water valve housing 124A. Cold water valve housing 124A can be connected to bridge 108 at a first end. Cold water valve 122A is held in place with cold water locking nut 126A. The position of the stem of the cold water valve 122A is controlled by a user manipulating cold water user control 130A and dictates how much cold water enters and exits cold water valve 122A (i.e., a flow rate of the cold water flowing through the cold water valve 122A). From the cold water valve 122A, the cold water is directed back into the bridge 108 where it mixes with hot water in a mixing chamber, and then passes to the outlet tube 102 and out of the faucet outlet.

Similarly, as shown and described in more detail with respect to FIG. 2, hot water enters the faucet assembly at hot water supply line 110B and passes to the bridge 108. From the bridge 108, the hot water enters hot water valve 122B which is situated within hot water valve housing 124B. Hot water valve housing 124B can be connected to bridge 108 at a second end. Hot water valve 122B is held in place with hot water locking nut 126B. The position of the stem of the hot water valve 122B is controlled by a user manipulating hot water user control 130B and dictates how much hot water enters and exits hot water valve 122B (i.e., a flow rate of the hot water flowing through the hot water valve 122B). From the hot water valve 122B, the hot water is directed back into the bridge 108 where it mixes with cold water in a mixing chamber, and then passes to the outlet tube 102 and out of the faucet outlet.

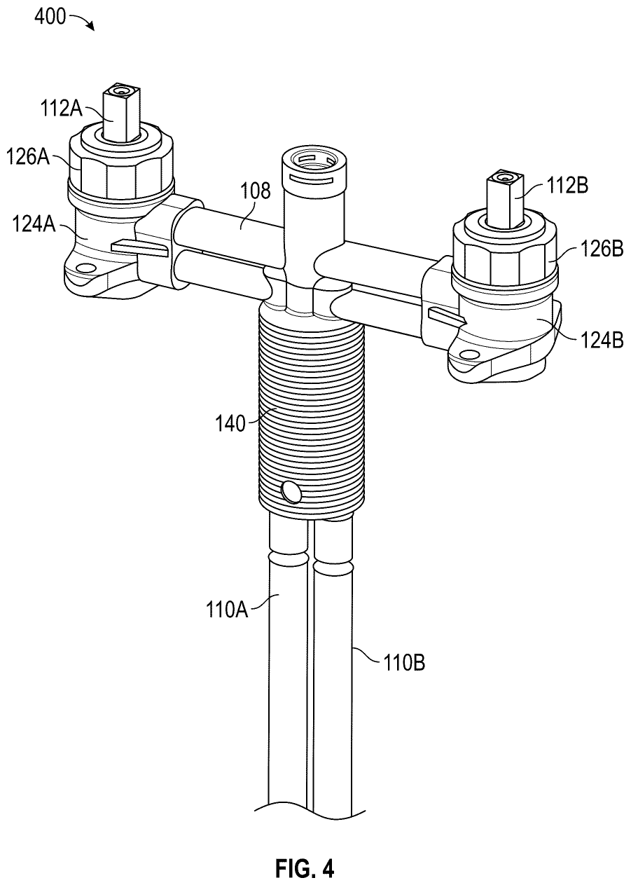

FIG. 4 shows a perspective view of a faucet assembly 400 having a central water inlet and comprising a central extended shank, according to some embodiments. A difference between this configuration shown here in FIG. 4 and the configurations shown elsewhere (e.g., FIG. 2, FIG. 3) is that the faucet assembly 400 includes a central shank 140 that is extended, or configured to pass through a central opening of a mounting surface. This configuration does not include side shanks that secure the faucet assembly to side openings. Therefore, the faucet assembly configuration shown in FIG. 4 can be mounted to a mounting surface having a single opening or a mounting surface having three openings (and configured for conventional dual-control faucet assemblies which require three openings). This allows more flexibility, since the dual-control faucet assembly 400 having only a central shank 140 that is extended (and not including extended side shanks) can be mounted to a mounting surface having either a single opening or three openings. In some embodiments, faucet assembly 400 may comprise a central extended shank but not extended side shanks.

Faucet assembly 400 of FIG. 4 includes cold water supply line 110A and hot water supply line 110B that are configured to connect to central shank 140. Central shank 140 is shown as a central extended shank, as described above, and can include two connections, one that receives a cold water supply line 110A and one that receives a hot water supply line 110B.A waterway through the central shank 140 allows water to pass from the cold water supply line 110A and to the bridge 108, and similarly, a second waterway through the central shank 140 allows water to pass from the hot water supply line 110B and to the bridge 108.

Faucet assembly 400 also includes cold water valve housing 124A and hot water valve housing 124B. Cold water valve housing 124A houses a cold water valve of the faucet assembly 400, and hot water valve housing 124B houses a hot water valve of the faucet assembly 400. The cold water valve is held in place with a locking nut 126A and the hot water valve is held in place with locking nut 126B. Finally, FIG. 4 shows the cold water valve stem 112A and the hot water valve stem 112B extending upwards from the cold water valve housing 124A and locking nut 126A, and hot water valve housing 124B and locking nut 126B, respectively.

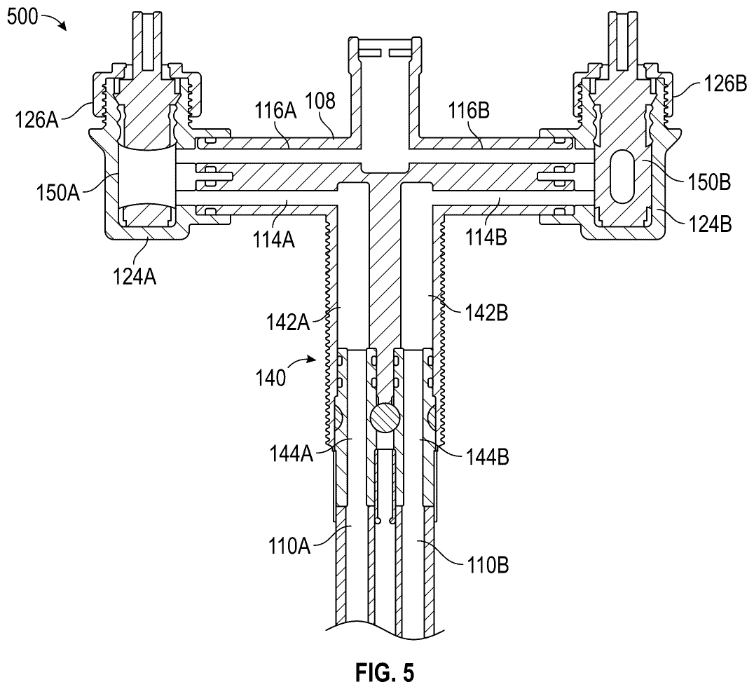

FIG. 5 shows a cross-sectional view of a faucet assembly 500 having a central water inlet and comprising a central extended shank, according to some embodiments.

Faucet assembly 500 is configured to receive cold water from a cold water supply at cold water supply line 110A. From cold water supply line 110A, the cold water passes to cold water pathway 142A of central shank 140. As shown, cold water supply line 110A is removably connected to the central shank 140 via connection 144A. From the cold water pathway 142A, the cold water flows to the bridge 108. In the bridge, the cold water flows to lower cold water pathway 114A, through which the cold water flows horizontally to the cold water valve 150A. Cold water valve 150A is controlled by a user at a cold water control (e.g., knob, handle). The amount of the cold water that flows into the cold water valve 150A directly depends on the relative location (e.g., rotation) of the cold water valve control. From the cold water valve 150A, the cold water flows to an upper cold water pathway 116A in the bridge 108. From the upper cold water pathway 116A in the bridge, the cold water flows in to a mixing chamber, where the cold water mixes with hot water from a hot water flow path.

Faucet assembly 500 is configured to receive hot water from a hot water supply at hot water supply line 110B. From hot water supply line 110B, the hot water passes to hot water pathway 142B of the central shank 140. As shown, hot water supply line 110B is removably connected to the central shank 140 via connection 144B. From the hot water pathway 142B, the hot water flows to the bridge 108. In the bridge, the hot water flows to lower hot water pathway 114B, through which the hot water flows horizontally to the hot water valve 150B. Hot water valve 150B is controlled by a user at a hot water control (e.g., knob, handle). The amount of hot water that flows into the hot water valve 150B directly depends on the relative location (e.g., rotation) of the hot water valve control. From the hot water valve 150B, the hot water flows to an upper hot water pathway 116B in the bridge 108. From the upper hot water pathway 116B in the bridge, the hot water flows into a mixing chamber, where the hot water mixes with cold water from the cold water pathway.

In some embodiments, lower cold water pathway 114A and lower hot water pathway 114B are configured to transport water horizontally away from a central location in the bridge 108. In some embodiments, upper cold water pathway 116A and upper hot water pathway 116B are configured to transport water horizontally toward a central location of the bridge 108. In some embodiments, cold water pathway 142A and hot water pathway 142B are configured to transport water vertically upwards to the bridge. In some embodiments, the upper cold water pathway 116A and the lower cold water pathway 114A are configured to transport cold water in opposite directions. In some embodiments, the upper hot water pathway 116B and the lower hot water pathway 114B are configured to transport hot water in opposite directions.

Bridge 108 may comprise engineering thermoplastics. In some embodiments, the engineering thermoplastics may include but is not limited to polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, or blends thereof. In some embodiments, bridge 108 may comprise a glass-filled polyamide or a glass-filled polyphthalamide. In some embodiments, bridge 108 may comprise an injection molded thermoplastic.

As shown in FIG. 5, cold water valve housing 124A houses cold water valve 150A, and locking nut 126A holds cold water valve 150A in place. Similarly, hot water valve housing 124B houses hot water valve 150B, and locking nut 126B holds hot water valve 150B in place.

As shown herein, the cold water pathways of the faucet assembly are shown on the left side of the assembly, and the hot water pathways of the faucet assembly are shown on the right side of the assembly (from the perspective of a user using the faucet assembly). However, this configuration can also be presented in an alternative configuration, where the hot water pathways are on the left, and the cold water pathways are on the right.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A faucet assembly comprising:
a bridge comprising a central water inlet configured to removably connect to a cold water supply line and a hot water supply line;
a cold water valve housed within a cold water valve housing comprising an extended shank configured to pass through a first opening in a mounting surface, wherein the cold water valve housing is connected to the bridge at a first end of the bridge and the cold water valve is configured to receive cold water from a lower cold water pathway in the bridge; and
a hot water valve housed within a hot water valve housing comprising an extended shank configured to pass through a second opening in the mounting surface, wherein the hot water valve housing is connected to the bridge at a second end of the bridge and the hot water valve is configured to receive hot water from a lower hot water pathway in the bridge,
wherein the bridge comprises a mixing chamber configured to receive cold water from the cold water valve via an upper cold water pathway in the bridge and hot water from the hot water valve via an upper hot water pathway in the bridge.

2. The faucet assembly of claim 1, wherein the upper cold water pathway is configured to transport cold water in a first direction and the lower cold water pathway is configured to transport cold water in a second direction, wherein the first direction and the second direction are opposite.

3. The faucet assembly of claim 1, wherein the upper hot water pathway is configured to transport water in a third direction and the lower hot water pathway is configured to transport water in a fourth direction, wherein the third direction and the fourth direction are opposite.

4. The faucet assembly of claim 1, wherein the upper cold water pathway is directly above the lower cold water pathway, and the upper hot water pathway is directly above the lower hot water pathway.

5. The faucet assembly of claim 1, wherein the bridge comprises an engineering thermoplastic selected from the group consisting of polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof.

6. The faucet assembly of claim 5, wherein the bridge comprises a glass-filled polyamide or a glass-filled polyphthalamide.

7. The faucet assembly of claim 1, wherein the mounting surface comprises the first opening for the extended shank of the cold water valve housing, the second opening for the extended shank of the hot water valve housing, and a central opening for the cold water supply line and the hot water supply line.

8. The faucet assembly of claim 1, wherein the cold water supply line and the hot water supply line are configured to connect to the bridge at a location that is below the mixing chamber of the bridge.

9. The faucet assembly of claim 1, comprising an outlet tube configured to removably connect to the bridge and receive mixed water from the mixing chamber.

10. A faucet assembly comprising:
a bridge comprising a central extended shank comprising a central water inlet configured to removably connect to a cold water supply line and a hot water supply line;
a cold water valve connected to the bridge at a first side and configured to receive cold water from a lower cold water pathway in the bridge; and
a hot water valve connected to the bridge at a second side and configured to receive hot water from a lower hot water pathway in the bridge,
wherein the bridge comprises a mixing chamber configured to receive cold water from the cold water valve via an upper cold water pathway in the bridge and hot water from the hot water valve via an upper hot water pathway in the bridge.

11. The faucet assembly of claim 10, wherein the central extended shank of the bridge comprises a cold water pathway connecting the cold water supply line to the lower cold water pathway of the bridge and a hot water pathway connecting the hot water supply line to the lower hot water pathway of the bridge.

12. The faucet assembly of claim 10, wherein the cold water valve is housed within a cold water valve housing that does not comprise an extended shank, and the hot water valve is housed within a hot water valve housing that does not comprise an extended shank.

13. The faucet assembly of claim 10, wherein the upper cold water pathway is configured to transport cold water in a first direction and the lower cold water pathway is configured to transport cold water in a second direction, wherein the first direction and the second direction are opposite.

14. The faucet assembly of claim 10, wherein the upper hot water pathway is configured to transport water in a third direction and the lower hot water pathway is configured to transport water in a fourth direction, wherein the third direction and the fourth direction are opposite.

15. The faucet assembly of claim 10, wherein the upper cold water pathway is directly above the lower cold water pathway, and the upper hot water pathway is directly above the lower hot water pathway.

16. The faucet assembly of claim 10, wherein the bridge comprises an engineering thermoplastic selected from the group consisting of polyamides, polyesters, polycarbonates, acrylonitrile-butadiene-styrene, polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof.

17. The faucet assembly of claim 16, wherein the bridge comprises a glass-filled polyamide or a glass-filled polyphthalamide.

18. The faucet assembly of claim 10, wherein the faucet assembly is configured to mount to a mounting surface comprising a single opening through which the central extended shank of the bridge is configured to pass through and a mounting surface comprising three openings, wherein the central extended shank of the bridge is configured to pass through a central opening of the three openings.

19. The faucet assembly of claim 10, wherein the cold water supply line and the hot water supply line are configured to connect to the bridge at a location that is below the mixing chamber of the bridge.

20. The faucet assembly of claim 10, comprising an outlet tube configured to removably connect to the bridge and receive mixed water from the mixing chamber.
